(19) United States
(12) Patent Application Publication
(10) Pub. No.: US 2005/0166170 A1
(43) Pub. Date: Jul. 28, 2005

(54) Field programmable platform array

(76) Inventors: Payman Zarkesh-Ha, Fremont, CA (US); William Loh, Fremont, CA (US); Chien-Hwa Chang, Cupertino, CA (US)

Correspondence Address: LSI LOGIC CORPORATION, 1621 BARBER LANE, MS: D-106, MILPITAS, CA, 95035, US

(21) Appl. No.: 10/764,803

(22) Filed: Jan. 26, 2004

(51) Int. Cl. G06F 17/50

(52) U.S. Cl. 716/16

(57) ABSTRACT

The present invention is directed to a field programmable platform array (FPPA). In an exemplary aspect of the present invention, a method for providing field programmable platform array units (PAUs) may include the following steps. First, N by M array of platform array units may be cut from a field programmable platform array wafer according to a customer's order, where N and M are positive integers. The field programmable platform array wafer is a wafer with all silicon layers and metal layers already built and includes a plurality of platform array units. The platform array units may be field programmable by a customer, and each platform array unit may include at least one core and at least one processor. Interconnect between any two of the platform array units may be pre-routed on chip. Next, the N by M array of platform array units may be packaged and tested. After the N by M array of platform array units are delivered to the customer, the N by M array of platform array units may be field programmed by the customer.

### CROSS REFERENCE TO RELATED APPLICATIONS

The present application herein incorporates U.S. patent application Ser. No. 10/626,825, entitled “Architecture for a Sea of Platforms”, filed Jul. 23, 2003, now pending, and U.S. patent application Ser. No. 10/044,781, entitled “Architecture for a Sea of Platforms”, filed Jan. 10, 2002, now U.S. Pat. No. 6,640,333 by reference in their entirety.

### FIELD OF THE INVENTION

The present invention relates generally to the field of semiconductors and integrated circuit design, and particularly to a field programmable platform array (FPPA).

### BACKGROUND OF THE INVENTION

Integrated circuits have become a necessary part of everyday modem society. From wireless phones and information handling systems, to household appliances and data storage systems, a wide range of integrated circuits are utilized to provide a broad range of functionality. To provide this functionality, integrated circuits may need to be specialized to have the functions necessary to achieve the desired results, such as through the provision of an application specific integrated circuit (ASIC). An ASIC is typically optimized for a given function set, thereby enabling the circuit to perform the functions in an optimized manner. However, there may be a wide variety of end-users desiring such targeted functionality, with each user desiring different functionality for different uses.

Additionally, more and more functions are being included within each integrated circuit. While providing a semiconductor device that includes a greater range of functions supported by the device, inclusion of this range further complicates the design and increases the complexity of the manufacturing process. Further, such targeted functionality may render the device suitable for a narrow range of consumers, thereby at least partially removing an “economy of scale” effect that may be realized by selling greater quantities of the device.

Thus, the application specific integrated circuit business is confronted by the contradiction that the costs of design and manufacture dictate high volumes of complex designs. Because of this, the number of companies fielding such custom designs is dwindling in the face of those rapidly escalating costs.

Time-to-market, cost of masks and performance are the main concerns in ASIC products. Although FPGA (field programmable gate array) provides the fastest time to market, FPGA may suffer from high NRE (nonrecurring engineering) cost. Platform-based integrated circuit design such as RapidChip™ developed by LSI Logic Corp., and the like, fills the gap between FPGA and ASIC. In a platform, cores are interconnected by a transistor array fabric, which may be configured by BEOL (back end of line) masks for metal (or late-metal) layers. Although most of the FEOL (front end of line) fabrication process and core design of a platform are completed for a slice, the BEOL masks still need be custom designed for the platform. A slice is a pre-manufactured chip in which all silicon layers have been built, leaving the top metal layers to be completed with the customer's unique IP (intellectual property). Moreover, sometimes the cost sharing advantage of a platform may not be realized because different capabilities are usually desired (e.g., trading speed with memory) within the platform. This means that different sizes of slices within a platform need be provided.

Therefore, it would be desirable to provide a field programmable platform array (FPPA). The FPPA may be pre-designed and pre-manufactured, in which all silicon layers and metal layers have been built. The FPPA may be composed arbitrarily and its filed programmable nature may decrease complexity in management and lead time.

### SUMMARY OF THE INVENTION

Accordingly, the present invention is directed to a FPPA. In a first exemplary aspect of the present invention, a method for providing field programmable platform array units may include the following steps. First, N by M array of platform array units may be cut from a field programmable platform array wafer according to a customer's order, where N and M are positive integers. The field programmable platform array wafer is a wafer with all silicon layers and metal layers already built and includes a plurality of platform array units. The platform array units may be field programmable by a customer, and each platform array unit may include at least one core and at least one processor. Interconnect between any two of the platform array units may be pre-routed on chip. Next, the N by M array of platform array units may be packaged and tested. After the N by M array of platform array units are delivered to the customer, the N by M array of platform array units may be field programmed by the customer.

In an additional exemplary aspect of the present invention, a semiconductor device may include two or more platform array units. Each of the platform array units may include at least one core and at least one processor. The platform array units may be field programmable by a customer. Interconnect between any two of the platform array units may be pre-routed on chip.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 shows an exemplary field programmable platform array in accordance with the present invention;

FIG. 2 shows an exemplary platform array unit in accordance with the present invention;

FIG. 3 shows exemplary on-chip inter-unit connections between two platform array units in accordance with the present invention;

FIGS. 4A, 4B and 4C show an exemplary interconnect architecture for PAU's communication in a cross-section view, a top view, and a 3D view, respectively, in accordance with the present invention;

FIG. 5 shows an exemplary interconnect layer comparison in accordance with the present invention; and

FIG. 6 is a flow chart illustrating an exemplary method for providing field programmable platform array units in accordance with the present invention.

### DETAILED DESCRIPTION OF THE INVENTION

Reference will now be made in detail to the presently preferred embodiments of the invention, examples of which are illustrated in the accompanying drawings.

Time-to-market, cost of masks and performance are the main concerns in ASIC products. Although FPGA (field programmable gate array) provides the fastest time to market, FPGA may suffer from high NRE (nonrecurring engineering) cost. Platform-based integrated circuit design such as RapidChip™ developed by LSI Logic Corp., and the like, fills the gap between FPGA and ASIC. In a platform, cores are interconnected by a transistor array fabric, which may be configured by BEOL (back end of line) masks for metal (or late-metal) layers. Although most of the FEOL (front end of line) fabrication process and core design of a platform are completed for a slice, the BEOL masks still need be custom designed for the platform. A slice is a pre-manufactured chip in which all silicon layers have been built, leaving the top metal layers to be completed with the customer's unique IP (intellectual property). Moreover, sometimes the cost sharing advantage of a platform may not be realized because different capabilities are usually desired (e.g., trading speed with memory) within the platform. This means that a platform needs to offer different sizes of slices within the platform market, and cost of masks and performance are the main concerns in ASIC products. Thus, it would be desirable to provide a field programmable platform array (FPPA). The FPPA is pre-designed and pre-manufactured, in which all silicon layers and metal layers have been built. The FPPA may be composed arbitrarily and its filed programmable nature may decrease complexity in management and lead time.

The present invention may leverage and extend the platform strategy (e.g., LSI Logic Corp.'s RapidChip™, and the like) to reduce time-to-market and cost of products even further more while maintaining comparable performance.

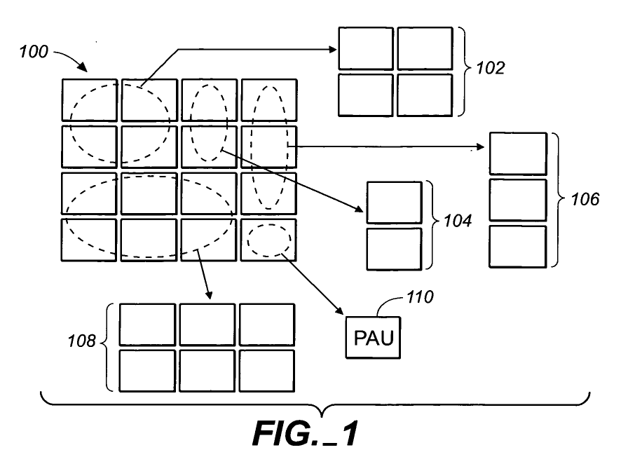

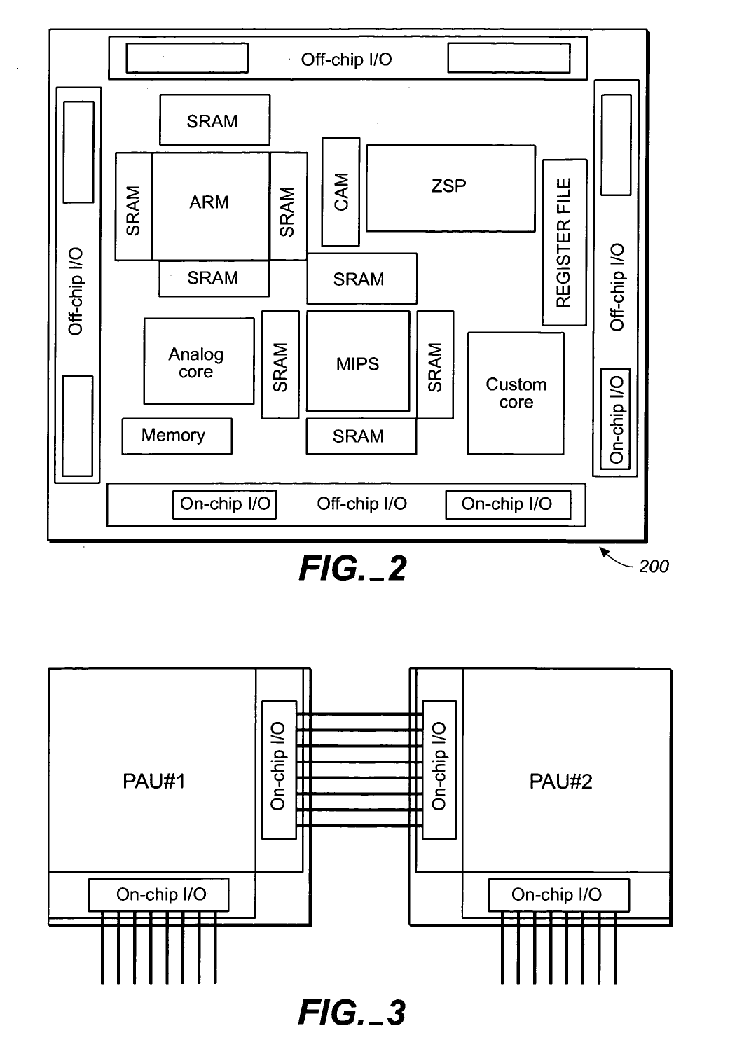

Referring now to FIG. 1, an exemplary field programmable platform array (FPPA) 100 in accordance with the present invention is shown. The FPPA 100 may include pre-designed and pre-manufactured platform tiles 102, 104, 106, 108 and 110. Each tile may include one or more platform array units (PAUs) and may be configured by external software programming. A PAU is a unit of a FPPA wafer. A FPPA wafer is a wafer with all silicon layers and metal layers already built and includes a plurality of PAUs. For example, the title 102 includes four PAUs, and the title 110 includes one PAU. According to the present invention, a FPPA wafer may include one or more dies, and one die may include one or more PAUs. The size of a FPPA (i.e., the number of PAUs) may be determined by dicing (i.e., a method of transforming wafers into dies). There is no need to do any more processing, i.e. all FPPA wafers are ready for die packaging. FIG. 2 shows an exemplary PAU 200 in accordance with the present invention. The PAU 200 may be used to compose the FPPA 100 shown in FIG. 1. As shown, the PAU 200 may include at least one core and at least one processor.

FIG. 3 shows exemplary on-chip inter-unit connections between two PAUs (PAU # 1 and PAU # 2) in accordance with the present invention. In a preferred embodiment, interconnect between PAUs is pre-routed on chip to avoid paying for off-chip overhead (e.g. package misalignment, ESD protection, or the like). The interconnect may be direct, via bus-bars, via network on chip, or the like.

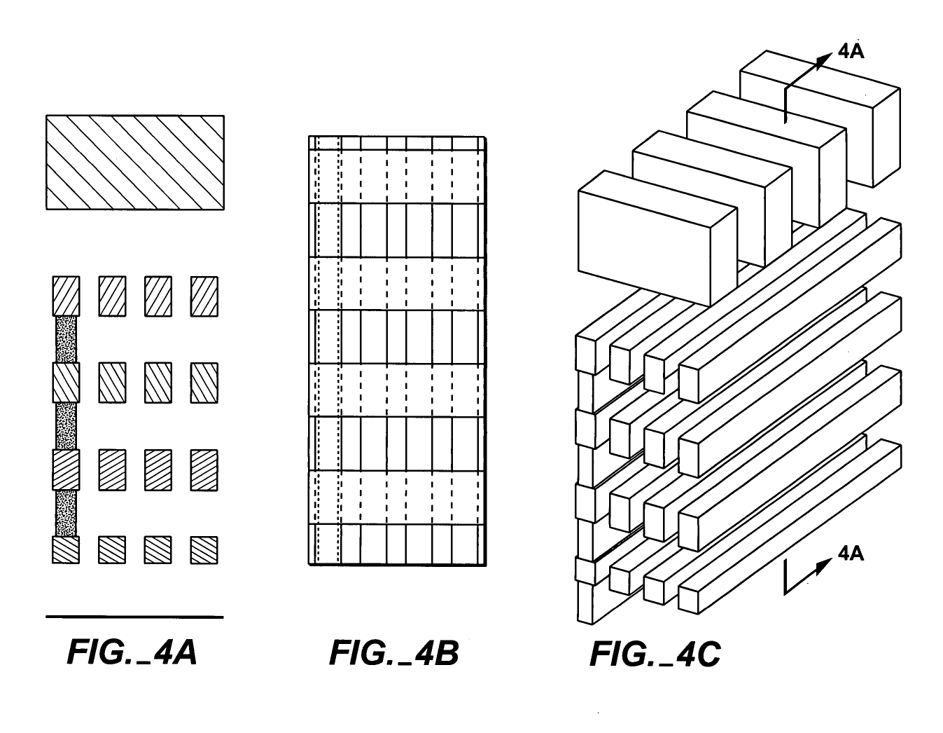

FIGS. 4A, 4B and 4C show an exemplary interconnect architecture for PAU's communication in a cross-section view, a top view, and a 3D view, respectively, in accordance with the present invention. In a preferred embodiment, the architecture uses top aluminum pads as a routing layer. The architecture may preserve the encapsulation of lower copper layers by a standard die seal (i.e., a continuous and surrounding band of metal wall that covers from the top metal all the way down to the silicon to shield the fragile Cu and Low K layers from being exposed to air).

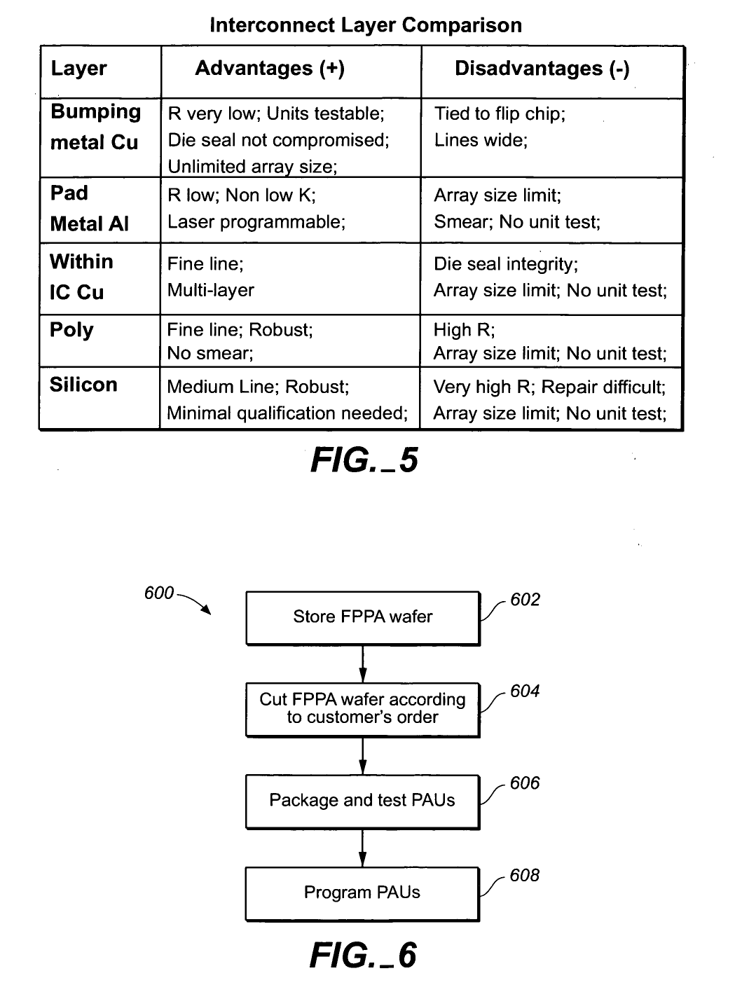

FIG. 5 shows an exemplary interconnect layer comparison in accordance with the present invention. According to the present invention, a bumping metal layer, a pad metal layer, a copper layer within an integrated circuit, a poly (i.e., polysilicon) layer, or a silicon layer may be used as a routing layer (i.e., interconnect layer) for interconnect between PAUs. Their respective advantages and disadvantages are shown in FIG. 5.

FIG. 6 is a flow chart illustrating an exemplary method or process 600 for providing field programmable PAUs in accordance with the present invention. The process 600 may start with a step 602 in which a FPPA wafer is stored or banked. A FPPA wafer is a wafer with all silicon layers and metal layers already built and includes a plurality of PAUs. For example, the FPPA wafer may be banked by a semiconductor manufacturer at a packaging vendor. Then, the FPPA wafer may be cut to provide PAUs to a customer 604. For example, a customer may order a N by M array of PAUs within a platform such as SAN (storage area network), DSP (digital signal processing), and the like, where N and M are positive integers. After the order is received, the semiconductor manufacturer or the packaging vendor may cut the N by M array of PAUs from the FPPA wafer in order to fill the order. Then, the N by M array of PAUs may be packaged and tested 606. After the customer receives the N by M array of PAUs, the customer may program the N by M array of PAUs 608. For example, the customer may program the N by M array of PAUs with firmware or the like for unit specialization, unit role assignment, inter-unit communications and the like. It is understood that here a unit represents a PAU.

It is understood that instead of cutting, bump metal may be put down for the N by M array of PAUs. In this case the PAUs may be pre-tested. Moreover, this is a more flexible approach since the bump interconnect may be designed and customized. However, this is not a field programmable approach.

According to the present invention, the FPPA has the following features. First, a FPPA die may include N by M array of PAUs to enable capability scaling to match different system requirements within a platform. In addition, the die complexity and capability are proportional to N*M (i.e., N times M). Thus, the present FPPA offers an enabling hardware method based on a subtracting wafer cutting technique. Moreover, the present PAUs may be configured by external software programming.

The present invention may have the following advantages. First, the present FPPA may leverage and extend the platform strategy (e.g., LSI Logic Corp.'s RapidChip™, and the like) to reduce time-to-market and cost of products even further. Additionally, the present FPPA may increase design and manufacturing cost sharing by matching capability with the die area. Moreover, the present FPPA may eliminate made-to-order lead time. Furthermore, the present FPPA may eliminate process options (e.g. need only LSI Logic Corp.'s Gflx 6+1+2R, and the like). In additional, the present FPPA may utilize green power management techniques (green power is a term used by some environmentalists to describe what they deem to be environmentally friendly sources of

It is understood that the specific order or hierarchy of steps in the processes disclosed is an example of exemplary approaches. Based upon design preferences, it is understood that the specific order or hierarchy of steps in the processes may be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

1. A method for providing field programmable platform array units, comprising:
cutting N by M array of platform array units from a field programmable platform array wafer according to an order from a customer, N and M being positive integers, said field programmable platform array wafer having all silicon layers and metal layers already built and including a plurality of platform array units, said plurality of platform array units being field programmable by a customer, each of said plurality of platform array units including at least one core and at least one processor, and interconnect between said plurality of platform array units being pre-routed on chip; and
packaging and testing said N by M array of platform array units.

2. The method of claim 1, further comprising:
programming said N by M array of platform array units by said customer.

3. The method of claim 2, wherein said programming is performed for at least one of unit specialization, unit role assignment, and inter-unit communications.

4. The method of claim 2, wherein said programming is performed with firmware.

5. The method of claim 1, wherein said N by M array of platform array units are within a single platform.

6. The method of claim 5, wherein said single platform is a storage area network (SAN) platform.

7. The method of claim 5, wherein said single platform is a digital signal processing (DSP) platform.

8. The method of claim 1, further comprising storing said field programmable platform array wafer.

9. A system for providing field programmable platform array units, comprising:
means for cutting N by M array of platform array units from a field programmable platform array wafer according to an order from a customer, N and M being positive integers, said field programmable platform array wafer having all silicon layers and metal layers already built and including a plurality of platform array units, said plurality of platform array units being field programmable by a customer, each of said plurality of platform array units including at least one core and at least one processor, and interconnect between said plurality of platform array units being pre-routed on chip; and
means for packaging and testing said N by M array of platform array units.

10. The system of claim 9, further comprising:
means for programming said N by M array of platform array units by said customer.

11. The system of claim 10, wherein said programming is performed for at least one of unit specialization, unit role assignment, and inter-unit communications.

12. The system of claim 10, wherein said programming is performed with firmware.

13. The system of claim 9, wherein said N by M array of platform array units are within a single platform.

14. The system of claim 13, wherein said single platform is a storage area network (SAN) platform.

15. The system of claim 13, wherein said single platform is a digital signal processing (DSP) platform.

16. The system of claim 9, further comprising means for storing said field programmable platform array wafer.

17. A semiconductor device, comprising:
a plurality of platform array units being field programmable by a customer, each of said plurality of platform array units including at least one core and at least one processor;
wherein interconnect between said plurality of platform array units being pre-routed.

18. The semiconductor device of claim 17, wherein top aluminum pads of said semiconductor device are used as a routing layer.

19. The semiconductor device of claim 18, wherein encapsulation of lower copper metal layers of said semiconductor device is preserved by a standard die seal.

20. The semiconductor device of claim 17, wherein metal bumps of said semiconductor device are used as a routing layer.

21. The semiconductor device of claim 17, wherein a copper layer within said semiconductor device is used as a routing layer.

22. The semiconductor device of claim 17, wherein a poly layer of said semiconductor device is used as a routing layer.

23. The semiconductor device of claim 17, wherein a silicon layer of said semiconductor device is used as a routing layer.

24. The semiconductor device of claim 17, wherein said plurality of platform array units are configured by external software programming.
